(19) United States
(12) Patent Application Publication
(10) Pub. No.: US 2010/0146605 A1
(43) Pub. Date: Jun. 10, 2010

(54) METHOD AND SYSTEM FOR PROVIDING SECURE ONLINE AUTHENTICATION

(75) Inventors: Bradley R. Hammell, Bridgeport, CT (US); Yassir Nawaz, Hamden, CT (US); Frederick W. Ryan, JR., Oxford, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/327,873

(22) Filed: Dec. 4, 2008

(51) Int. Cl. G06F 21/20

(52) U.S. Cl. 726/7

(57) ABSTRACT

Methods and systems for authenticating website users without exposing passwords or other sensitive information to potential theft are provided. When the user's computer connects to a website server all communications are routed through a secure authentication device. When the authentication device identifies the need for user information to be submitted to the website server, the application retrieves the required information from memory and inserts the information into the appropriate location in the website forms. Since the secure connection to the website server is established in the secure boundary of the authentication device, the information is protected from being obtained by any malware that may reside in the user's computer.

### FIELD OF THE INVENTION

The invention disclosed herein relates generally to networked based transactions, and more particularly to a method and system for authenticating users conducting transactions over networks while maintaining the security of information used for such authentication.

### BACKGROUND OF THE INVENTION

As the popularity of the Internet has grown, so too has the popularity of conducting transactions over the Internet. Such transactions could include, for example, the purchase of goods or services, bill payments, account management (e.g., credit card or bank accounts), and the like. One thing that most, if not all, of the websites that allow users to perform such transactions have in common is the use of passwords to authenticate users that connect to them over a network, such as the Internet or other type of network, e.g., LAN or the like. Typically, the password is transmitted over a secure channel that is established between the user's personal computer and the website server. While these passwords are secure during the transmission, there is still a very real threat to the security of these passwords from malicious programs that may be located on the user's own computer. Malicious software, sometimes referred to as malware, on the user's computer can steal passwords and other sensitive information, e.g., account numbers, encryption keys, etc., that are stored in a memory of the user's computer and send this information to a remote location for unauthorized use. Hardware and software key-loggers can be used to obtain passwords and other information as they are typed by the user. Software key-loggers can also capture information from the display of the user's computer that is entered using a mouse or on-screen keyboard.

There are several solutions that address the above threats to security of information. For example, one-time use passwords can be generated on demand and ensure that even if a password is stolen, it is of no value as it is invalid for future use. These passwords are generated through a token carried by the user which is synchronized with the website's one-time use password authentication server. The disadvantage of such one-time use passwords is that a separate token and one-time use password authentication server is required for each secure website. As another example, password stores are used to securely stored passwords on the user's computer. Some password stores are even implemented on portable media such as a flash drive for portability. This allows the user to securely store several passwords and enter them in websites without having to type them from a keyboard. While this defeats key loggers, the passwords have to be retrieved and decrypted form the password store before they are entered into the browser, at which time they can be stolen by malware. Thus, current solutions are cost prohibitive or do not provide sufficient protection.

### SUMMARY OF THE INVENTION

The present invention alleviates the problems associated with the prior art and provides methods and systems for authenticating website users without exposing passwords or other sensitive information to potential theft.

In accordance with the present invention, an authentication device includes a processing unit and memory contained within a secure boundary. The authentication device is in communication with a user's computer. When the user's computer connects to a website server, via a browser running on the user's computer, all communications are routed through the authentication device. An application running on the processor of the authentication device acts as a proxy server to the browser running on the user's computer, and the authentication device, via the application, securely connects to the website server requested by the browser. When the authentication device identifies the need for user information to be submitted to the website server, the application retrieves the required information from the memory, e.g., passwords, account numbers, or other sensitive information, and inserts the information into the appropriate location in the website forms before encrypting and sending them directly to the website server. Since the secure connection to the website server is established in the secure boundary of the authentication device, and the information is encrypted before being sent outside of the authentication device, the information is protected from being obtained by any malware that may reside in the user's computer.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a system for providing secure online authentication according to an embodiment of present invention;

FIG. 2 illustrates in block diagram form a system for providing secure online authentication according to another embodiment of the present invention;

FIG. 3 illustrates in flow diagram form a portion of the processing performed for secure online authentication according to an embodiment of the present invention; and

FIG. 4 illustrates in flow diagram form a portion of the processing performed for secure online authentication according to an embodiment of the present invention.

### DETAILED DESCRIPTION OF THE PRESENT INVENTION

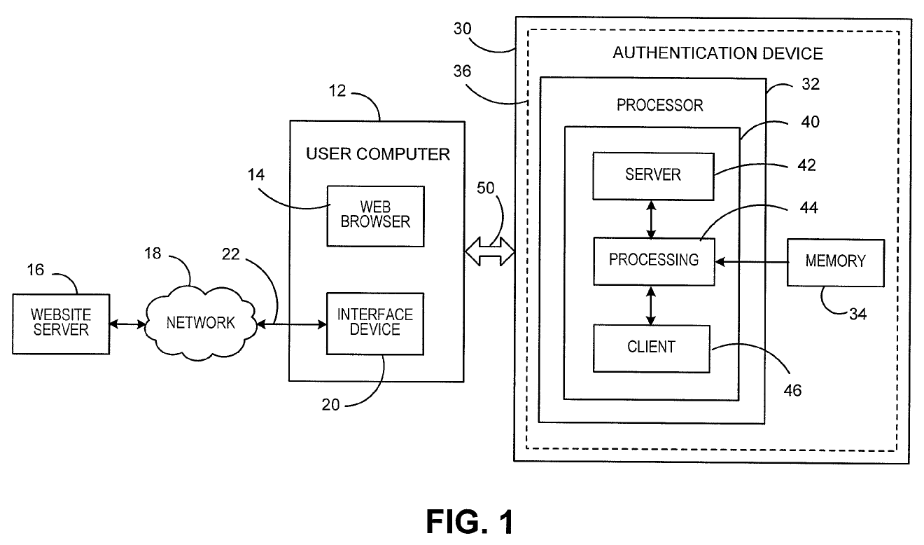

In describing the present invention, reference is made to the drawings, wherein there is seen in FIG. 1 a system for providing secure online authentication according to an embodiment of the present invention. A user utilizes a user computer 12, such as a personal computer or the like, to run a web browser 14 to communicate with a website server 16 via a network 18, e.g., the Internet or other type of network. The user computer 12 utilizes an interface device 20, e.g., network card, modem, or the like, to establish a communication link 22 with the website server 16 via the network 18.

As shown in FIG. 1, the web browser 14 of the user computer 12 does not communicate directly with the website server 16, but instead all communications pass through an authentication device 30 that is provided according to the present invention. Authentication device 30 can be coupled to the user computer 12 via a communication link 50, such as, for example, a USB interface or the like. Authentication device 30 includes a processor 32 and a memory device 34. Authentication device 30 could be implemented as a portable computer, dongle, smart card, cell phone or other type of device that includes a processor and memory device. Memory device 34 is utilized to store sensitive information, e.g., passwords, user names, account numbers, social security numbers, and the like, that may be utilized by a user when conducting a transaction online using the user computer 12. The processor 32 and memory 34 are preferably located within a secure boundary denoted by the dotted line 36. Such boundary could be secured, for example, by a tamper grid, encapsulation, or the like that protects the data stored within the memory 34 and the operation of the processor 32 from improper attack or intrusion. In this manner, the data stored within the memory 34 is securely stored and not susceptible to being stolen or otherwise improperly obtained for unauthorized use.

A software application 40 runs on the processor 32 to control the operation of the authentication device 30. Application 40 includes three main subcomponents: a server component 42, a processing component 44, and a client component 46. The server component 42 acts as a proxy server to the web browser 14 running on the user computer 12 via the communication link 50. Thus, when the web browser 14 is utilized by a user to request a webpage (based on a webpage address) from a website server 16, the request is routed to the server component 42 of the authentication device 30 via the communication link 50 such that the request is passed through the authentication device 30 instead of being sent directly to the website server 16. The server component 42 forwards the request to the client component 46 via the processing component 44, and the client component 46 establishes a communication with the appropriate website server 16 (based on the webpage address) via the communication link 50 and, as illustrated in FIG. 1, the interface device 20 of the user computer 12, thereby removing the necessity of having such an interface device duplicated within the authentication device 30. The client component 46 is responsible for maintaining the security of the communications with the website server 16, including encryption/decryption of communications, and secure exchange of any web pages to and from the requested website server 16.

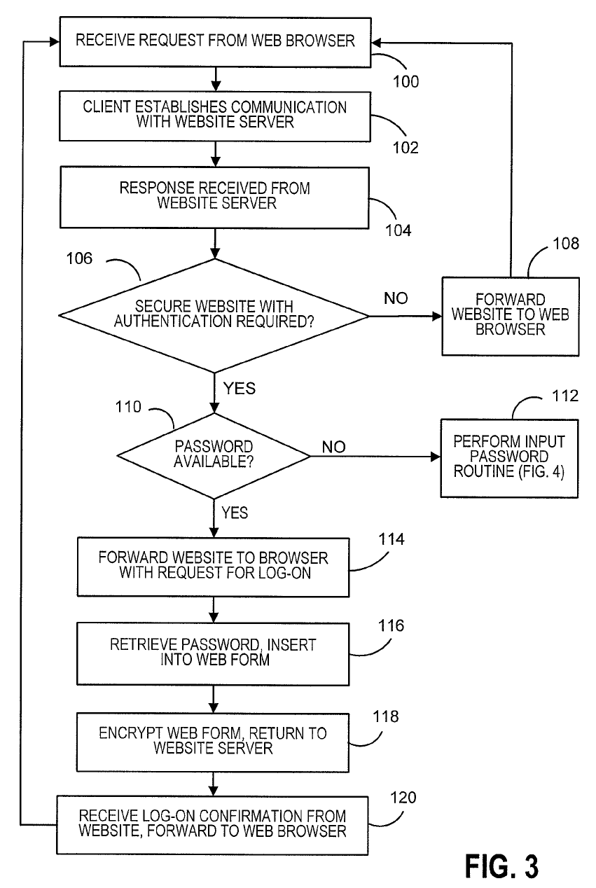

The processing component 44 functionally sits between the server component 42 and client component 46, and controls the main operations of the authentication device 30. It controls the passing of the communications between the server component 42 and client component 46, and the processing thereof as described below. The operation of the authentication device 30 is described with respect to the flow diagram illustrated in FIG. 3. In step 100, the server component 42 receives a request from the web browser 14 for a website initiated by a user of the user computer 12. The server component 42 forwards the request to the processing component 44, which forwards it to the client component 46. In step 102, the client component 46 establishes a communication with the appropriate website server 16 (if not already established) or utilizes a pre-established communication link, and sends the request to the website server 16. The communication link is preferably a secure link utilizing, for example, a Secure Socket Layer (SSL). In step 104, the client component 46 receives a response from the website server 16, i.e., a web page, via the communication link 22 and 50, and sends it to the processing component 44. In step 106, the processing component 44 determines if the response being returned by the website server 16 is from a secure website and if the web page requires an authentication of the user. Determining if a website is a secure site can be performed, for example, by authenticating the digital certificate provided along with the website. This ensures that the returned website is the actual website requested and is not an unauthorized attempt to improperly obtain personal information (often referred to as a phishing attack). Determining if authentication of the user is required can be performed, for example, by examining the field tags that are provided within the web page which indicate the type of fields. Thus, if a field is a password field, there will be a tag associated with that field indicating it is a password field. If there is no authentication required, then the authentication device 30 need not be utilized, and the web page can be passed to the server component 42 for forwarding to the web browser 14 of the user computer 12 without any additional processing in step 108 and the processing can then return to step 100 to wait for the next request from the web browser 14.

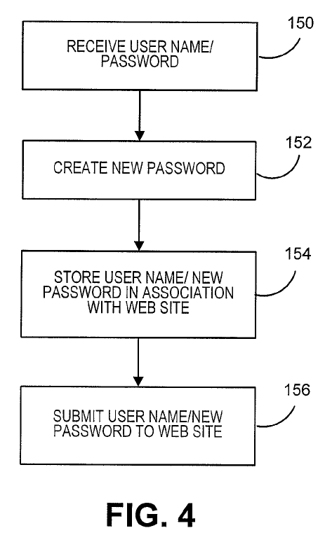

If it is determined in step 106 that the website is a secure site and authentication is required, then in step 110 it is determined if the password associated with the particular website is stored in the memory 34. This can be performed, for example, utilizing a look-up table stored in the memory 34 that associates websites with passwords and optionally other required information (account numbers, etc.) that may be utilized as described further below. If in step 110 it is determined that a password is not available, then in step 112 the processing component 44 can allow the user to perform a password input routine described with respect to FIG. 4. If in step 110 it is determined that the password is available in the memory device 34, then in step 114 the processing component 44 forwards the website to the user's web browser 14, via the server 42, along with a request for log-on to be provided by the user. Upon receiving the request to log-on to the website from the user, indicating that the user desires to use the authentication device 30 to log into the website, then in step 116 the processing component 44 retrieves the password from the memory 34 and inserts the password (and optionally user name) into the appropriate locations of the web page. Alternatively, step 114 need not be performed, and the processing component 44 can retrieve the password and insert it into the web page without a request from the user. In step 118, the processing component 44 encrypts the web form, if necessary, and returns the encrypted web form to the website server 16. Additionally, in step 118 the processing component 44 could also optionally return the web form to the user's web browser 14, but without the password information completed, to indicate to the user that the log-on procedure is being performed by the authentication device 30. If desired, the password field in the website returned to the web browser 14 could be filled with dots or asterisks to show the field was completed by the authentication device 30. However, the real password information is not provided back to the web browser 14, therefore making it unavailable in any form to the web browser 14 and only available in encrypted form when passed through the interface device 20 of the computer 12. Therefore, it cannot be obtained by any malicious software that may reside on the user computer 12.

All of the processing performed by the authentication device 30 is transparent to the website server 16, and the website server 16 need not have any knowledge of or familiarity with the authentication device 30, nor does it need to have a separate secure session established with the user computer 12. As far as the website server 16 is concerned, the authentication procedure is being performed by the user using the user computer 12. Thus, the website server 16 need not establish two different secure sessions (website server/user computer and website server/authentication device) and maintain an association between the two sessions to indicate that the authentication device is being used to provide authentication for a specific session established with the user computer. In this manner, the authentication device 30 of the present invention requires no changes to existing authentication protocols required by existing website servers, and can be utilized without any changes in communication protocols or increase in overhead. In step 120, when the client component 46 receives a confirmation response from the website server 16 with respect to the log-on attempt, the confirmation is sent to the web browser 14 (via the server component 42) and the user can now conduct the desired transaction with the website. The processing can then return to step 100 to wait for additional requests from the web browser 14. Since the information sent from the authentication device 30 to the website server 16 is encrypted before it is sent, the information never appears in unencrypted form outside of the authentication device 30, thereby protecting the information from being stolen or improperly obtained.

In addition to inserting the password into the appropriate location in the webpage in step 116, the processing component 44 can also optionally insert other types of information into the appropriate fields of the webpage as well. Based upon prior history of inputs to a specific webpage, the processing component 44 can keep track of information that may be required to be entered into the webpage for the user to conduct a transaction, e.g., user name, account numbers, and the like, along with the locations in the webpage into which such information is to be entered. This information could be stored in the memory 34 and retrieved as necessary. In this manner, the information can be protected in the same way as the password is protected, and need not be entered into a webpage from the user computer 12 each time a webpage is accessed, thereby reducing the chance that such information will be stolen by any malicious software that may reside on the user computer 12.

FIG. 4 illustrates in flow diagram form the processing performed by the authentication device 30 when a password input routine is performed. This routine can be performed, for example, when a user desires to utilize the authentication device 30 to log into a website for the first time and the password is not yet stored in the memory 34 of the authentication device 30, or alternatively if the user desires to change an existing password. In step 150, the user is prompted to input a password for the desired website, optionally along with a corresponding user name. Since the password will be input from the user computer 12, there is a risk that the password could be stolen by malware residing on the user computer 12 when it is input by the user. To protect against this, in step 152 the processing component 44, upon receipt of the password input by the user, will generate a new password to replace the password input by the user. In step 154, the user name and new password are stored in the memory 34 in association with the website. In step 156, the user name and new password are sent to the website, in encrypted form, such that the website will register the user name and new password for authentication purposes. Thus, a new password, which was not input via the user computer 12 or available in any form on the user computer 12, is registered with the website. In this manner, even if the original password input by the user was stolen by software on the user computer 12 when it was input only the one time, it will have no value as it is not the password registered by the website for authentication purposes.

While the processing performed in step 152 will render the password entered by the user useless to an attacker, it also renders the password unknown to the user. Thus, if the user ever needs to log into a website and does not have the authentication device 30, the user will be unable to log in, as the user will not know the password registered with the website. Thus, the processing in step 152, while preferable, may be optional to allow the user to select the actual password used. While this does not provide the same security as if a new password is generated by the authentication device 30, it will still significantly reduce the chances of the password being stolen. By having the authentication device 30 insert the password into the web page instead of having the user enter the password using the user computer 12 each time the user is attempting to log into a website, the password is not available on the user computer 12 except for the first time the password is registered with the website. By reducing the number of times the password is actually available in the user computer 12 to only the first time it is entered, there is significantly less risk of the password being stolen then if it were made available multiple times. Additionally, the user having to input a password in step 150 has two functions—to ensure the user understands that a new password is being entered, and as a trigger for the authentication device to generate a new password in step 152. It should be understood that the user having to input a password in step 150 may be optional, and instead the user can simply indicate that a new password is to be generated by the authentication device, such as for example, by making an appropriate selection on a displayed menu.

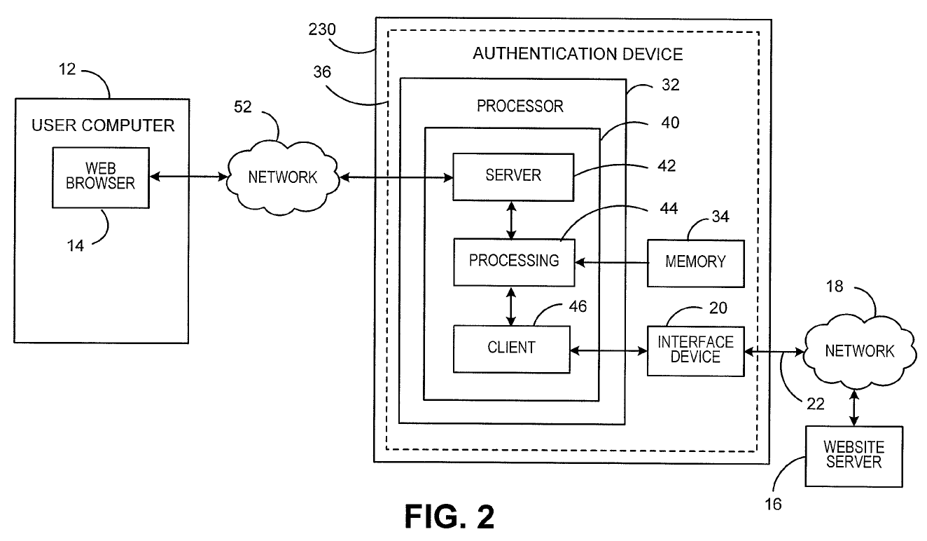

FIG. 2 illustrates in block diagram form a system for providing secure online authentication according to another embodiment of the present invention. FIG. 2 is similar to FIG. 1, except that an authentication device 230 is remotely connected to the user computer 12 via a network 52, such as a Local Area Network (LAN), home network, or the like. Authentication device 230 is similar to authentication device 30 of FIG. 1, except that it includes its own interface device 20, as in this embodiment all communications between the authentication device 230 and the website server 16 are routed independently of the user computer 12. The authentication device 230 could be implemented as part of a network server, router or the like, such that a user can utilize the authentication device 230 from any user computer 12 that is coupled to the network 52. Preferably, the user computers 12 are securely coupled to the network 52, using, for example, SSL communication security. The operation of the authentication device 230 as illustrated in FIG. 2 is similar as described with respect to the authentication device 30 with respect to FIGS. 3 and 4, and need not be repeated here. Any information stored in the memory 34 of the authentication device 230 is not provided to the user computer 12, and therefore not available on the user computer 12 for potential theft by malware that may be on the user computer 12.

By utilizing the authentication devices as described above when performing an authentication procedure for online transactions, sensitive information can be protected from being obtained by malicious software that may reside on the user's computer.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. An authentication device for authenticating a user to conduct a transaction over a network, the device comprising:
a memory device for storing authentication information, and
a processor coupled to the memory device, the processor being adapted to receive a request for a website from a user computer coupled to the authentication device, establish a communication link with a website server and forward the request to the website server, receive a response from the website server, the response including a web page, determine if the web page requires authentication of the user, if authentication of the user is not required, forward the web page to the user computer, if authentication of the user is required, obtain from the memory the authentication information associated with the web page, insert the authentication information into the web page, encrypt the web page with the authentication information inserted therein, and send the encrypted webpage to the website server using the communication link for authentication of the user by the website server.

2. The authentication device of claim 1, wherein the authentication information includes a user password.

3. The authentication device of claim 2, wherein the authentication information further includes a user name.

4. The authentication device of claim 2, wherein the authentication information further includes an account number.

5. The authentication device of claim 1, further comprising:
a secure boundary surrounding the memory device and processor.

6. The authentication device of claim 1, wherein the processor is further adapted to receive authentication information at the authentication device from the user computer, generate new authentication information, and store the new authentication information in association with the web page in the memory device.

7. A method for authenticating a user using an authentication device coupled to a user computer being utilized by the user, the method comprising:
receiving, at the authentication device, a request for a website from the user computer;
establishing, by the authentication device, a communication link with a website server and forwarding the request to the website server;
receiving a response from the website server, the response including a web page;
determining, in the authentication device, if the web page requires authentication of the user;
if authentication of the user is not required, forwarding the web page to the user computer;
if authentication of the user is required, obtaining from a memory within the authentication device authentication information associated with the web page;
inserting, in the authentication device, the authentication information into the web page;
encrypting, in the authentication device, the web page with the authentication information inserted therein; and
sending the encrypted webpage to the website server using the communication link for authentication of the user by the website server.

8. The method of claim 7, wherein determining if the web page requires authentication information further comprises:
determining if field tags provided in the web page include a field for authentication information.

9. The method of claim 7, wherein determining if the web page requires authentication information further comprises:
determining if the web page is a secure web page.

10. The method of claim 9, wherein determining if the web page is a secure web page further comprises:
authenticating a digital certificate provided with the web page.

11. The method of claim 7, wherein obtaining from a memory within the authentication device authentication information associated with the web page further comprises:
determining if the authentication information associated with the web page is already stored in the memory; and
if the authentication information associated with the web page is not already stored in the memory, performing an authentication information input routine to establish authentication information for the web page for storage in the memory.

12. The method of claim 11, wherein performing an authentication information input routine further comprises:
receiving authentication information at the authentication device from the user computer;
generating new authentication information in the authentication device;
storing the new authentication information in association with the web page in the authentication device; and
inserting, in the authentication device, the new authentication information into the web page.

13. The method of claim 7, wherein the authentication information includes a user password.

14. The method of claim 13, wherein the authentication information further includes a user name.

15. The method of claim 13, wherein the authentication information further includes an account number.
